(19) United States
(12) Patent Application Publication
(10) Pub. No.: US 2002/0070159 A1
(43) Pub. Date: Jun. 13, 2002

(54) Split leaf filter

(76) Inventor: Michael S. Reedy, Hamburg, NY (US)

Correspondence Address: Walter W. Duft, Law Office of Walter W. Duft, 10255 Main Street, Suite 10, Clarence, NY, 14031, US

(21) Appl. No.: 09/835,827

(22) Filed: Apr. 16, 2001

Related U.S. Application Data
(60) Provisional application No. 60/198,921, filed on Apr. 21, 2000.

(51) Int. Cl. B01D 29/05; B01D 29/72

(52) U.S. Cl. 210/332; 210/346; 210/486

(57) ABSTRACT

A split leaf filter includes a filter shell having disposed therein a sluice manifold, at least one outlet manifold, a vibrator bar, and an array of parallel spaced split leaf assemblies. Each split leaf assembly has at least two split leaf elements arranged in coplanar adjacent relationship (twin split leaf design), and in some designs there may be three or more coplanar split leaf elements per split leaf assembly (multiple split leaf design). Each split leaf element has a first edge section connected to one of the outlet manifolds, and a second edge section that is generally parallel to the first edge section and connected to the vibrator bar. Each split leaf element also has third and fourth edge sections that are generally perpendicular to the first and second edge sections. In twin split leaf designs, the third edge section is longitudinally interconnected with corresponding edge sections of split leaf elements in a set or section of adjacent split leaf assemblies. Each such set or section represents fewer than all of the split leaf assemblies disposed in the split leaf filter. The fourth edge section is arranged in adjacent parallel relationship along the substantial entirety thereof with a corresponding edge section of another split leaf element of the same split leaf assembly. The outermost split leaf elements of multiple split leaf designs also have this edge configuration. For interior split leaf elements of multiple split leaf designs, both the third and fourth edge sections are arranged in adjacent parallel relationship along the substantial entirety thereof with a corresponding edge section of another split leaf element of the same split leaf assembly.

### CROSS-REFERENCE TO RELATED APPLICATIONS

This application claims the benefit of U.S. Provisional Application No. 60/198,921, filed on Apr. 21, 2000.

### STATEMENT REGARDING FEDERALLY SPONSORED RESEARCH OR DEVELOPMENT

Not Applicable

### BACKGROUND OF THE INVENTION

1. Field of the Invention

This invention relates to liquid filtration through pressure leaf filters.

2. Description of the Prior Art

By way of background, pressure leaf filters are high-rate, sub micron solids removal liquid filtration devices using a number of pressure leaf filtration elements and a filteraid. An unfiltered liquid is pumped into a vessel under pressure, where it is forced through the filtration elements. The filtration elements are precoated with the filteraid (diatomaceous earth, perlite, cellulose, carbon, rice hulls, etc.), which allows the filtration elements to remove sub micron particles. The filtration elements are commonly called “leaves.” The filter leaves act as septums (support and drainage members) for the filteraid and removed solids. To that end, the filter leaves have internal drain connections, typically located at the bottom thereof, that permit the filtered liquid to pass to the outside of the pressure vessel. Pressure leaf filters are commonly called cake filters because the removed solids form a cake on the surface of the filter leaves. These filters can be vertical or horizontal vessels. The filter leaves conform to the vessel shape and are dimensionally large in large vessels.

In recent years, filter sizes have increased to cope with ever increasing flow requirements and ever decreasing limits on the amount of allowable solids in the filtered liquids. Large filters and large filter leaves pose a variety of operational problems. The leaves need to be removed from the filter for periodic maintenance. In addition, if a liquid is supersaturated, post precipitation occurs in the core of the leaves requiring leaf removal and power washing. The large leaves may be five feet or more per side and weigh over 80 pounds each. As such, they generally cannot be removed from the filter by one person without a mechanical advantage like a crane, or hoist. Additionally, more than one person is typically required to remove and reinstall the associated leaf support mechanisms because they are long, heavy and require alignment to the full set of leaves.

Large leaves also cause a restriction to filtrate drainage and result in unbalanced cake formation, which causes cake bridging. The term bridging refers to parts of two adjacent cakes touching to form a low pressure zone in a common plane, with untouching cakes as higher pressure zones. This creates uneven forces that can bend the leaves and destroy the uniformity of the cake forming spaces. This affects cycle time and further enhances leaf damage.

Accordingly, there is a need for leaf filter having pressure leaf filtration elements (leaves) that can be physically installed and removed by one person. In particular, the filter leaves need to be amenable to being secured in place by one person even if they are partially damaged. The filter leaves further need to maintain a large filtration area but not hinder flow so as to promote uneven cake formation.

### SUMMARY OF THE INVENTION

The foregoing problems are solved and an advance in the art is obtained by a novel split leaf filter. The split leaf filter includes a filter shell having disposed therein a sluice manifold, at least one outlet manifold, a vibrator bar, and an array of parallel spaced split leaf assemblies. Each split leaf assembly has at least two split leaf elements arranged in coplanar adjacent relationship (twin split leaf design), and in some designs there may be three or more coplanar split leaf elements per split leaf assembly (multiple split leaf design). Each split leaf element has a first edge section connected to one of the outlet manifolds, and a second edge section that is generally parallel to the first edge section and connected to the vibrator bar.

Each split leaf element also has third and fourth edge sections that are generally perpendicular to the first and second edge sections. In twin split leaf designs, the third edge section is longitudinally interconnected with corresponding edge sections of split leaf elements in a set or section of adjacent split leaf assemblies. Each such set or section represents fewer than all of the split leaf assemblies disposed in the split leaf filter. The fourth edge section is arranged in adjacent parallel relationship along the substantial entirety thereof with a corresponding edge section of another split leaf element of the same split leaf assembly. The outermost split leaf elements of multiple split leaf designs also have this edge configuration. For interior split leaf elements of multiple split leaf designs, both the third and fourth edge sections are arranged in adjacent parallel relationship along the substantial entirety thereof with a corresponding edge section of another split leaf element of the same split leaf assembly.

A novel segmented leaf nest support system is also provided that allows the aforementioned sets or section of split leaf assemblies to be installed and interconnected in a split leaf filter by a single person. In another aspect of the invention, a split leaf element, as summarized above, is provided for use in forming a split leaf assembly in a split leaf filter. In a still further aspect of the invention, a split leaf element assembly kit, comprising a split leaf assembly, as summarized above, is provided for use in a split leaf filter.

### BRIEF DESCRIPTION OF THE DRAWING

The foregoing and other features and advantages of the invention will be apparent from the following more particular description of preferred embodiments of the invention, as illustrated in the accompanying Drawing, in which:

FIG. 1 is a transverse cross-sectional view of a prior art pressure leaf filter;

FIG. 2 is a partial cross-sectional view taken along line 2-2 in FIG. 1 showing a leaf spacing and longitudinal interconnection structure of the prior art pressure leaf filter of FIG. 1;

FIG. 3 is a partial enlarged end view of a leaf spacing and longitudinal interconnection structure of the prior art pressure leaf filter of FIG. 1;

FIG. 4 is a partial enlarged side view of a vibrator bar system of the prior art pressure leaf filter of FIG. 1;

FIG. 5 is a transverse cross-sectional view of a split leaf filter constructed in accordance with the invention;

FIG. 6 is a partial enlarged side view of a vibrator bar system of the split leaf filter of FIG. 5;

FIG. 7 is a partial enlarged end view of a leaf spacing and longitudinal interconnection structure of the split leaf filter of FIG. 5;

FIG. 8 is a longitudinal cross-sectional view of the split leaf filter of FIG. 5;

FIG. 9A is a partial enlarged side view of a connection between a top retainer and a vibrator bar of the split leaf filter of FIG. 5;

FIG. 9B is a partial enlarged side view of a connection between a split leaf element and a top retainer of the split leaf filter of FIG. 5; and

FIG. 10 is a partial enlarged side view of a leaf spacing and longitudinal interconnection structure of the split leaf filter of FIG. 5.

### DETAILED DESCRIPTION OF PREFERRED EMBODIMENTS

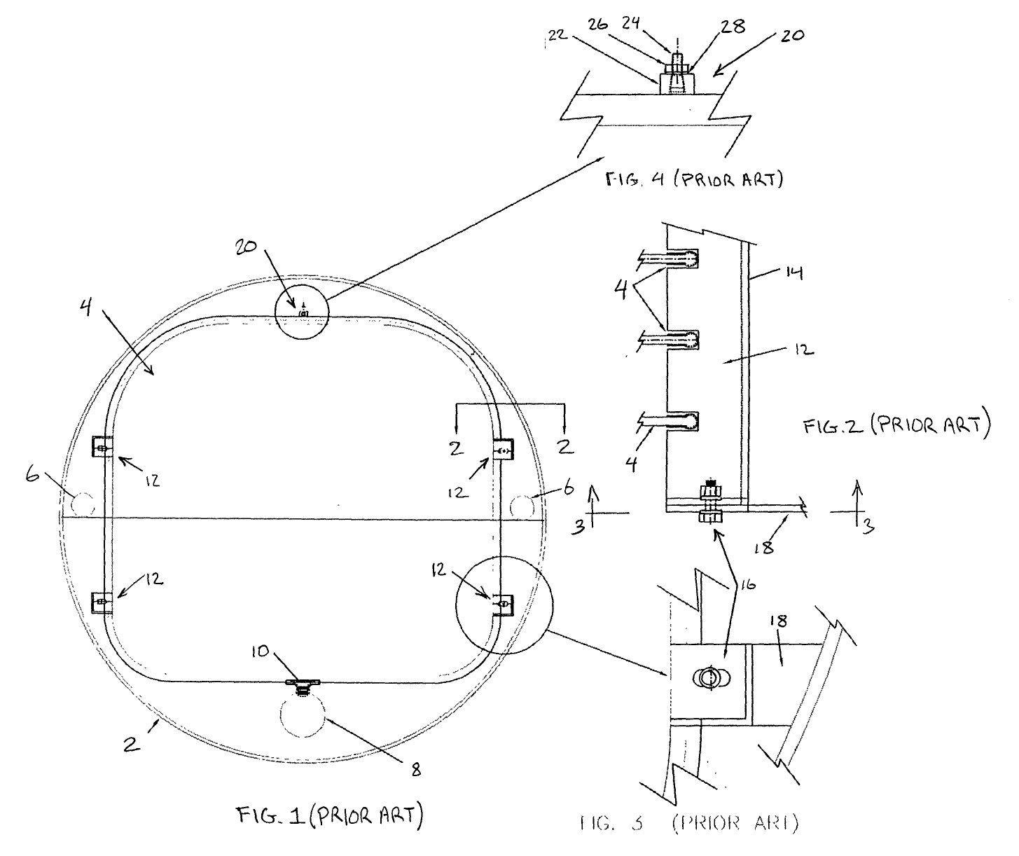

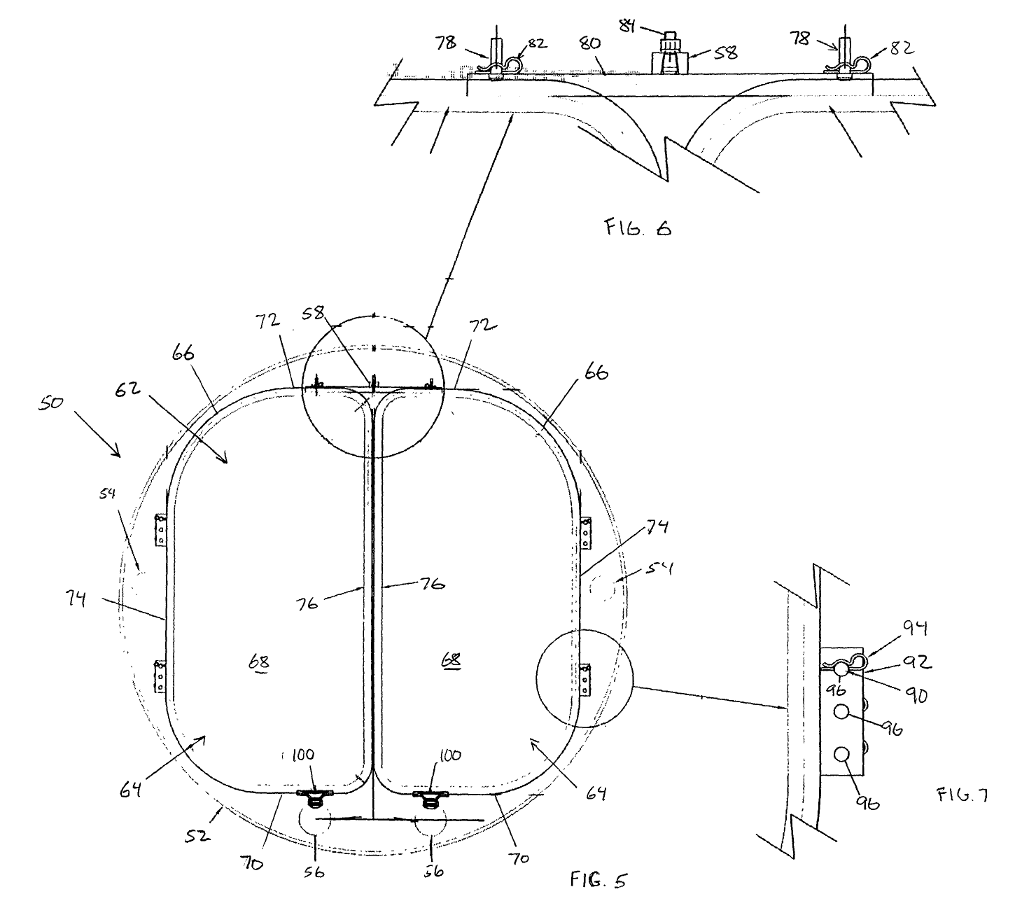

In order to more fully appreciate the present invention shown in FIGS. 5-10 of the drawing figures, a review of the prior art filtration element and pressure leaf filter of FIG. 1 will now be presented. This prior art design, referred to by way of background above, is known as a retractable leaf or retractable shell leaf bundle pressure leaf filter. It includes a filter shell 2 that houses a parallel array of full leaf filtration elements (filter leaves), one of which is illustrated by reference numeral 4. Each full leaf 4 is large (e.g., over five feet per side) and may weigh 80 pounds or more. There may be a substantial number of such leaves (e.g., twenty or more) within the filter shell 2. Also disposed within the filter shell 2 are a pair of sluice manifolds 6 and an outlet manifold (filtrate header) 8, the respective functions of which are well known in the art. Each full leaf 4 is connected at 10 to drain filtrate material into the outlet manifold 8. Each full leaf 4 is also laterally connected at 12 to the filter shell 2. The details of one such connection 12 are shown in FIGS. 2 and 3. In particular, a slotted bar 14 is mounted longitudinally within the filter shell by bolting each end thereof via a laterally adjustable connection 16 to a support member 18. The support member 18 is welded to the interior surface of the filter shell 2. The lateral adjustability of the connection 16 allows the slotted bar to be moved into and out of engagement with the full leaves 4 during filter assembly and disassembly. The top of each full leaf 4 is connected at 20 to a longitudinally extending vibrator bar 22. In particular, as shown in FIG. 4, a vibrator stud 24 is welded to the top of the full leaf 4 and extends upwardly through an aperture in the vibrator bar 20. A vibration nut 26 and a vibration washer 28 secure the connection.

As stated by way of background above, the prior art full leaf filter design of FIGS. 1-4 poses a variety of operational problems due to the large size of the leaves 4 and the need for a mechanical aid such as a crane or hoist to manipulate the leaves during filter assembly and disassembly. It is also difficult to align the slotted bars 14 to the full set of leaves 4. As additionally mentioned, the large size of the leaves 4 results in unbalanced cake formation, which causes cake bridging and uneven forces that can bend the leaves and destroy the uniformity of the cake forming spaces.

Turning now to FIG. 5, the leaf construction and support parts for an exemplary twin split leaf filter 50 of the invention are shown. The filter 50 includes a filter shell 52 that is of generally tubular construction and has a longitudinal axis extending perpendicular to the plane of FIG. 5. Disposed within the filter shell 52 are a pair of sluice manifolds 54, and a pair of outlet manifolds 56 (filtrate headers). As shown more clearly in FIG. 6, the filter shell 52 also houses a longitudinally extending vibrator bar 58.

As can be seen in FIG. 8, the filter shell is substantially filled with a longitudinal array 60 of split leaf assemblies 62. As best shown in FIG. 5, each split leaf assembly 62 is composed of two symmetrical (right and left) split leaf elements 64, each of which is formed with a metal leaf frame 66 surrounding a central filter screen assembly 68 of conventional design. On each split leaf element 64, the leaf frame 66 defines a first lower edge section 70, a second upper edge section 72, and third and fourth side edge sections 74 and 76. The lower side edge section 70 of each split leaf element 64 is adapted for mounting to one of the outlet manifolds 56. The upper edge section 72 of each split leaf element 64 extends generally parallel to the first edge section 70 and is adapted for mounting to the vibrator bar 58. The side edge sections 74 and 76 are generally parallel to each other and generally perpendicular to the lower and upper edge sections 70 and 72. The side edge section 74 of each split leaf element 64 is adapted for longitudinal interconnection with corresponding edge sections of split leaf elements 64 that are in adjacent split leaf assemblies 62. The side edge section 76 of each split leaf element 64 is arranged along the substantial entirety thereof in adjacent (preferably contacting) parallel relationship with the side edge section 76 of the mating split leaf element 64 of a single split leaf assembly 62.

Turning now to FIG. 6, and as can be further seen in FIG. 9B, each split leaf element 64 has a retainer stud 78 welded or otherwise secured to the upper edge section 72. The retainer studs 78 of split leaf elements 64 forming a single split leaf assembly 62 fit into corresponding holes in a common top retainer support channel 80 that spans the two split leaf elements 64. The retainer studs 78 are fixed in place by hairpin style retainers 82 that pass through a hole (not shown) in each retainer stud 78. The top retainer 80 is itself attached to the longitudinally-extending vibrator bar 58 using a vibrator stud 84 that is welded to the top retainer 80, a vibrator nut 86, and a vibrator washer 88. Alternatively, a pair of parallel spaced vibrator bars (not shown) could be used and the split leaf elements 64 could each be mounted to a respective one of the vibrator bars, i.e., whichever is closest. In either case, the foregoing construction allows the split leaf filter elements 64 to be independently attached to the vibrator bar 58, rather than the single full leaf 4 of FIG. 1.

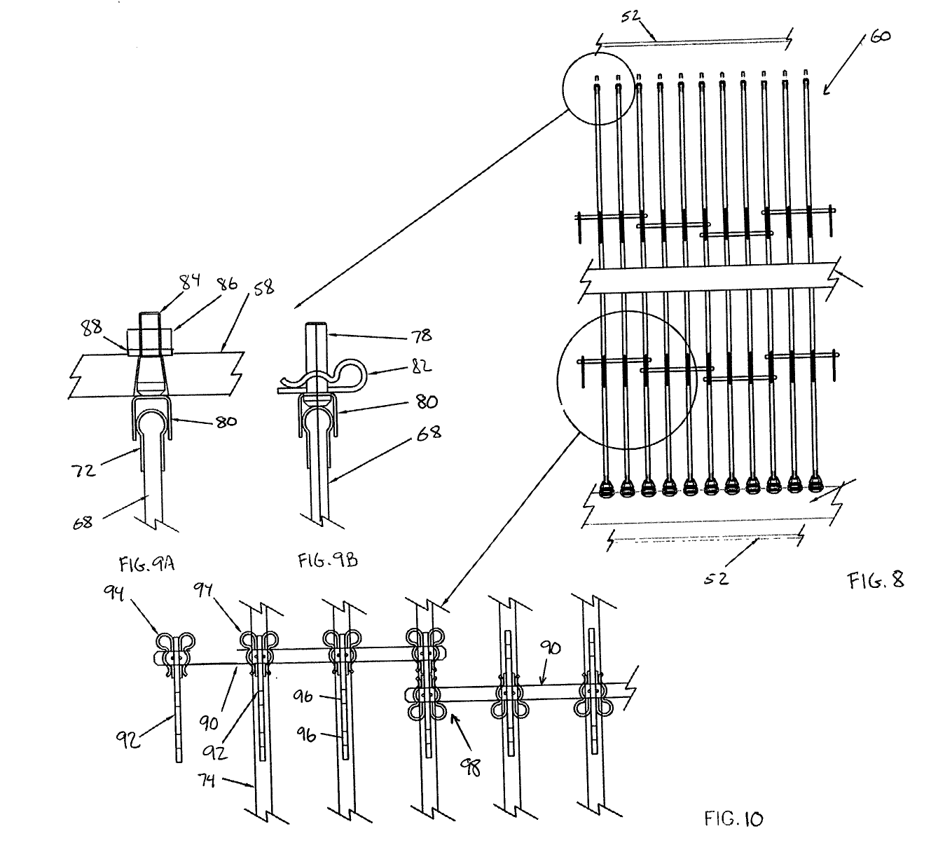

As can be seen in FIGS. 1, 7, 8 and 10, the split leaf elements 64 are further supported by leaf spacer bars 90 that slide through mutually aligned leaf spacer tabs 92 welded to the side edge sections 74 of each split leaf element 64. The spacer bars 90 and the spacer tabs 92 are connected together in sections by locking hairpins 94. The spacer bars 90 are alternated between sets of two, three or more holes 96 (three are shown) that are formed in each of the spacer tabs 92. This allows for the grouping of sets of split leaf assemblies 62 and installation/removal thereof as segmented sections of the split leaf assembly array 60 (see FIGS. 8 and 10). In particular, the use of multiple holes 96 facilitates the placement of two spacer bars 90 through a single split leaf assembly that is common to two split leaf assembly sets or sections, to thereby interconnect the same (as shown at 98 in FIG. 10). Interconnection of adjacent split leaf assembly sets is performed until the entire array 60 is formed. Each segmented set or section may include two, three, four or more split leaf assemblies 62 (four are shown). This further enhances the ergonomics of one-person operation of the leaf filter 50. Indeed, as described above relative to FIGS. 1-4, previous filter leaf support mechanisms were installed by aligning and supporting an entire array of leaves at one time into several longitudinally extending slotted bars 14. This typically required the assistance of more than one person.

The segmented leaf nest support system described herein also allows an operator to install and secure split leaf assemblies 62 that have bent by cake bridging, which is a common problem. The spacer bars 90 and the spacer tabs 92 can be maneuvered into position with more ease than trying to align a long notched support bar 14 full of leaf elements.

Returning now to FIG. 1, it will be seen that there are two parallel spaced outlet manifolds 56 respectively attached to the split leaf elements 64 via filtrate discharge nozzles 100. By making the outlet manifolds 56 smaller in diameter than the single larger manifold 8 shown in the prior art leaf filter system of FIG. 1, the split leaf elements 64 can be made longer from top to bottom insofar as more space is available within the filter shell 52. The amount of outlet manifold size reduction is preferably selected so that the split leaf elements 64 can be lengthened enough to compensate for the loss of filtering surface area caused by the addition of the two side edge sections 76 at the center of each split leaf assembly 62 (see FIG. 5). If more than two coplanar leaf filter elements are used per split leaf assembly, corresponding additional outlet manifolds of appropriate (i.e., smaller) diameter can be used. Alternatively, a single outlet manifold could be used, with appropriate connecting structure being provided to attach the filtrate discharge nozzles 100 thereto.

Accordingly, a split leaf filter has been shown and described. In the exemplary constructions illustrated in the drawing figures, a twin split leaf design is implemented in which two symmetrical mirror image split leaf elements are used to replace one large filter leaf. The twin split leaf design divides a single large filter leaf into two equal halves. As previously indicated, a multiple split leaf design could also be implemented that extends the concept of the twin split leaf design by dividing one large filter leaf into three or more co-planar split leaf elements. Regardless of the number of split leaf elements used, the elements may be arranged to discharge filtrate into separate outlet manifolds via separate filtrate discharge nozzles. This dual or multiple discharge arrangement balances flow and differential pressure for even cake formation because of the reduced distance to the discharge nozzle. Alternatively, as previously indicated, the split leaf elements may be adapted to discharge filtrate into a single common outlet manifold.

The split leaf elements are sized and configured such that their weight and shape permits one person to easily install or remove them. For example, by dividing the full leaf 4 of FIG. 1 (which could weigh about 80 pounds) into a twin split leaf assembly, an operator would only need to manipulate split leaf elements that weigh about 40 pounds each. The installation and removal process thus requires no mechanical assistance such as cranes or hoists. The novel leaf support attachment system described herein also allows one person to secure a full set of leaves during the installation process, progressing one set or section at a time, even if there are some leaves with damage due to bending.

While various embodiments of the invention have been shown and described, it should be apparent that many variations and alternative embodiments could be implemented in accordance with the invention. It is understood, therefore, that the invention is not to be in any way limited except in accordance with the spirit of the appended claims and their equivalents.

What is claimed is:

1. A split leaf filter, comprising:
a filter shell;
a sluice manifold disposed in said filter shell;
at least one outlet manifold disposed in said filter shell;
a vibrator bar disposed in said filter shell;
an array of parallel spaced split leaf assemblies disposed in said filter shell;
said split leaf assemblies each comprising at least two split leaf elements arranged in coplanar adjacent relationship;
said split leaf elements each having a first edge section connected to one of said outlet manifolds;
said split leaf elements each having a second edge section that is generally parallel to said first edge section and connected to said vibrator bar;
at least some of said split leaf elements having a third edge section that is generally perpendicular to said first and second edge sections and longitudinally interconnected with corresponding edge sections of split leaf elements in a set of adjacent ones of said split leaf assemblies, said set representing fewer than all of said split leaf assemblies disposed in said split leaf filter; and
said split leaf elements each having a fourth edge section arranged in adjacent parallel relationship along the substantial entirety thereof with a corresponding fourth edge section of another split leaf element of the same split leaf assembly.

2. A split leaf filter in accordance with claim 1 wherein said array of split leaf assemblies is oriented generally parallel to said vibrator bar.

3. A split leaf filter in accordance with claim 1 wherein said split leaf assemblies are twin split leaf assemblies comprising two symmetrical split leaf elements;

4. A split leaf filter in accordance with claim 1 wherein said at least one outlet manifold comprises a number of outlet manifolds that equals the number of split leaf elements in one of said split leaf assemblies;

5. A split leaf filter in accordance with claim 1 wherein a filtrate discharge nozzle is mounted on each of said first split leaf element edge sections and connected to one of said outlet manifolds.

6. A split leaf filter in accordance with claim 1 wherein a retainer bar connects said second split leaf element edge sections of split leaf elements in a single split leaf assembly to said vibrator bar.

7. A split leaf filter in accordance with claim 5 wherein said retainer bar is removably mounted to said split leaf elements.

8. A split leaf filter in accordance with claim 1 wherein, for each interconnected set of said split leaf assemblies, there is at least one spacer bar mounted to said third split leaf element edge sections of split leaf elements in each interconnected split leaf assembly.

9. A split leaf filter in accordance with claim 8 wherein there are two spacer bars mounted to said third split leaf element edge sections.

10. A split leaf filter in accordance with claim 9 wherein said spacer bars are received through apertured tabs connected to said third split leaf element edge sections.

11. A split leaf filter in accordance with claim 10 wherein said apertured tabs include plural apertures to facilitate alternative placement of said spacer bars and to allow split leaf assemblies that are common to two of said interconnected sets of split leaf assemblies to receive spacer bars associated with each set and thereby facilitate joinder of adjacent ones of said interconnected sets.

12. A split leaf element for use in forming a split leaf assembly in a split leaf filter, said split leaf element comprising:
a first edge section adapted to mount to an outlet manifold in said split leaf filter;
a second edge section generally parallel to said first edge section and adapted to mount to a vibrator bar in said split leaf filter;
a third edge section adapted for interconnection with a third edge section of a split leaf element of an adjacent split leaf assembly in said split leaf filter; and
a fourth edge section that is adapted to be arranged in adjacent parallel relationship along the substantial entirety thereof with a corresponding fourth edge section of a mating split leaf element of a common split leaf assembly.

13. A split leaf element in accordance with claim 12 wherein said first edge section has a filtrate discharge nozzle mounted thereto for connection to said outlet manifold.

14. A split leaf element in accordance with claim 11 wherein said second edge section has a retainer stud mounted thereto for connection to a retainer bar that mounts to said vibrator bar.

15. A split leaf element in accordance with claim 14 wherein said retainer stud is adapted for removable connection to said retainer bar.

16. A split leaf element in accordance with claim 12 wherein said third edge section has at least one leaf spacer tab mounted thereto, said spacer tab having at least one aperture therein for receiving a leaf spacer bar that interconnects a set of split leaf assemblies in said split leaf filter.

17. A split leaf element in accordance with claim 16 wherein said spacer tab has plural apertures therein for receiving plural leaf spacer bars that join two of said interconnected sets of split leaf assemblies.

18. A split leaf assembly kit for a split leaf filter, comprising;
a pair of split leaf elements, each split leaf element having:
a first edge section;
a filtrate discharge nozzle secured to said first edge section and adapted for connection to a pressure leaf filter outlet manifold;
a second edge section;
a stud secured to said second edge section and adapted to for connection to a top retainer member;
a top retainer member;
a third edge section;
a spacer tab secured to said third edge section, said spacer tab being apertured to receive a leaf spacer bar;
one or more leaf spacer bars; and
a fourth edge section adapted to be arranged in adjacent parallel relationship along the substantial entirety thereof with a corresponding fourth edge section of the other split leaf element of said pair.

19. A split leaf assembly kit in accordance with claim 18 wherein means for removably securing said one or more leaf spacer bars to said spacer tab.

20. A split leaf filter, comprising:
a filter shell, said filter shell being generally tubular in configuration and having a longitudinal axis;
a pair of sluice manifolds extending longitudinally in said filter shell;
a pair of outlet manifolds extending longitudinally in said filter shell;
a vibrator bar extending longitudinally in said filter shell;
a longitudinal array of parallel spaced split leaf element pairs disposed in said filter shell;
each split leaf element pair having two symmetrical split leaf elements arranged in coplanar side-by-side relationship at mutually adjacent edge sections thereof;
said mutually adjacent edge sections being parallel to each other and in mutual contacting relationship along the substantial entirety thereof;
each split leaf element of said split leaf element pairs further having first and second edge sections that are generally perpendicular to said mutually adjacent edge sections, and a third edge section that is spaced from and generally parallel to said mutually adjacent edge sections;
a filtrate discharge nozzle mounted to said first edge section of each of said split leaf elements, said discharge nozzle being mounted to an associated one of said one outlet manifolds;
a retainer stud extending from said second edge section of each of said split leaf elements;
a top retainer removably mounted to said retainer studs of each of said split leaf element pair, said top retainer further being centrally connected to said vibrator bar;
a pair of leaf spacer tabs mounted to said third edge section of each of said split leaf elements, each of said leaf spacer tabs having at least two apertures located at predetermined locations such that the spacer tab apertures on longitudinally adjacent ones of said split leaf element pairs are in mutual longitudinal coaxial alignment and define at least two aperture levels;
a plurality of leaf spacer bars interconnecting sets of longitudinally adjacent ones of said split leaf element pairs, each said set representing fewer than all of said split leaf element pairs disposed in said split leaf filter;
said spacer bars of each adjacent set of split leaf element pairs being received through alternating aperture levels of said spacer tabs to facilitate alternative placement of said spacer bars and to allow split leaf element pairs that are common to two of said interconnected sets to receive spacer bars associated with each set and thereby facilitate joinder of adjacent ones of said interconnected sets.
